(19) United States
(12) Patent Application Publication
(10) Pub. No.: US 2011/0166937 A1
(43) Pub. Date: Jul. 7, 2011

(54) Media output with micro-impulse radar feedback of physiological response

(75) Inventors: Mahalaxmi Gita Bangera, Renton, WA (US); Roderick A. Hyde, Redmond, WA (US); Muriel Y. Ishikawa, Livermore, CA (US); Edward K.Y. Jung, Bellevue, WA (US); Jordin T. Kare, Seattle, WA (US); Eric C. Leuthardt, St. Louis, MO (US); Nathan P. Myhrvold, Bellevue, WA (US); Elizabeth A. Sweeney, Seattle, WA (US); Clarence T. Tegreene, Bellevue, WA (US); David B. Tuckerman, Lafayette, CA (US); Lowell L. Wood, JR., Bellevue, WA (US); Victoria Y.H. Wood, Livermore, CA (US)

(73) Assignee: Searete LLC, Bellevue, WA (US)

(21) Appl. No.: 12/925,407

(22) Filed: Oct. 20, 2010

Related U.S. Application Data
(63) Continuation-in-part of application No. 12/655,808, filed on Jan. 5, 2010.
Application No. 12/655,808 is a continuation-in-part of application No. 12/924,036, filed on Sep. 17, 2010.

(51) Int. Cl. G06Q 30/00; G06Q 90/00

(52) U.S. Cl. 705/14.58; 705/14.66; 705/500

(57) ABSTRACT

A system and method for providing media and/or advertising content determines content and/or parameters responsive to physical and/or physiological information about a viewer detected by a micro-impulse radar (MIR).

### CROSS-REFERENCE TO RELATED APPLICATIONS

The present application is related to and claims the benefit of the earliest available effective filing date(s) from the following listed application(s) (the “Related Applications”) (e.g., claims earliest available priority dates for other than provisional patent applications or claims benefits under 35 USC §119(e) for provisional patent applications, for any and all parent, grandparent, great-grandparent, etc. applications of the Related Application(s)).

### RELATED APPLICATIONS

For purposes of the USPTO extra-statutory requirements, the present application constitutes a continuation-in-part of U.S. patent application Ser. No. 12/655,808, entitled MICRO-IMPULSE RADAR DETECTION OF A HUMAN DEMOGRAPHIC AND DELIVERY OF TARGETED MEDIA CONTENT, naming Mahalaxmi Gita Bangera, Roderick A. Hyde, Muriel Y. Ishikawa, Edward K. Y. Jung, Jordin T. Kare, Eric C. Leuthardt, Nathan P. Myhrvold, Elizabeth A. Sweeney, Clarence T. Tegreene, David B. Tuckerman, Lowell L. Wood, Jr., and Victoria Y. H. Wood as inventors, filed Jan. 5, 2010, which is currently co-pending, or is an application of which a currently co-pending application is entitled to the benefit of the filing date.

For purposes of the USPTO extra-statutory requirements, the present application constitutes a continuation-in-part of U.S. patent application Ser. No. 12/924,036, entitled CONTROL OF AN ELECTRONIC APPARATUS USING MICRO-IMPULSE RADAR, naming Mahalaxmi Gita Bangera, Roderick A. Hyde, Muriel Y. Ishikawa, Edward K. Y. Jung, Jordin T. Kare, Eric C. Leuthardt, Nathan P. Myhrvold, Elizabeth A. Sweeney, Clarence T. Tegreene, David B. Tuckerman, Lowell L. Wood, Jr., and Victoria Y. H. Wood as inventors, filed Sep. 17, 2010, which is currently co-pending, or is an application of which a currently co-pending application is entitled to the benefit of the filing date.

The United States Patent Office (USPTO) has published a notice to the effect that the USPTO's computer programs require that patent applicants reference both a serial number and indicate whether an application is a continuation or continuation-in-part. Stephen G. Kunin, Benefit of Prior-Filed Application, USPTO Official Gazette Mar. 18, 2003, available at http://www.uspto.gov/web/offices/com/sol/og/2003/week11/patbene.htm. The present Applicant Entity (hereinafter “Applicant”) has provided above a specific reference to the application(s)from which priority is being claimed as recited by statute. Applicant understands that the statute is unambiguous in its specific reference language and does not require either a serial number or any characterization, such as “continuation” or “continuation-in-part,” for claiming priority to U.S. patent applications. Notwithstanding the foregoing, Applicant understands that the USPTO's computer programs have certain data entry requirements, and hence Applicant is designating the present application as a continuation-in-part of its parent applications as set forth above, but expressly points out that such designations are not to be construed in any way as any type of commentary and/or admission as to whether or not the present application contains any new matter in addition to the matter of its parent application(s).

All subject matter of the Related Applications and of any and all parent, grandparent, great-grandparent, etc. applications of the Related Applications is incorporated herein by reference to the extent such subject matter is not inconsistent herewith.

### SUMMARY

According to an embodiment, a method for selecting at least one media parameter for media output to at least one person includes receiving micro-impulse radar (MIR) data corresponding to a region, the MIR data including information associated with a first physiological state corresponding to a person in the region, selecting one or more media parameters responsive to the first physiological state, and outputting a media stream corresponding to the one or more media parameters to the region.

According to an embodiment, a system for providing a media stream to a person responsive to a physiological response of the person includes a MIR system configured to detect, in a region, a first physiological state associated with a person and a media player operatively coupled to the MIR system and configured to play media to the region responsive to the detected first physiological state associated with the person.

According to an embodiment, a method for targeted electronic advertising includes outputting at least one first electronic advertising content, detecting with a MIR at least one physiological or physical change in a person exposed to the first electronic advertising content, correlating the at least one physiological or physical change in the person with a predicted degree of interest in the first electronic advertising content, and outputting at least one second electronic advertising content responsive to the predicted degree of interest in the first electronic advertising content.

According to an embodiment, a system for providing electronic advertising includes an electronic advertising output device configured to output electronic advertising to a region, a MIR configured to probe at least a portion of the region and output MIR data, and an electronic controller system configured to receive the MIR data and determine at least one of a physical or physiological state of a person within the region, correlate the determined at least one physical or physiological state to a predicted degree of interest in electronic advertising content output via the electronic advertising output device, and select electronic advertising content or change a presentation parameter for output via the electronic advertising output device responsive to the predicted degree of interest.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE FIGURES

FIG. 1 is a simplified block diagram of a micro-impulse radar (MIR), according to an embodiment.

FIG. 2 is a flow chart showing an illustrative process for determining the presence of a person in a region with the MIR of FIG. 1, according to an embodiment.

FIG. 3 is a flow chart showing an illustrative process for determining a physiological parameter of a person in a region with the MIR of FIG. 1, according to an embodiment.

FIG. 4 is a flow chart showing an illustrative process for selecting at least one media parameter for media output to at least one person, according to an embodiment.

FIG. 5 is a block diagram of a system for providing a media stream to a person responsive to a physiological response of the person, according to an embodiment.

FIG. 6 is a flow chart showing an illustrative process for targeting electronic advertising, according to an embodiment.

FIG. 7 is a block diagram of a system for providing electronic advertising, according to an embodiment.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here.

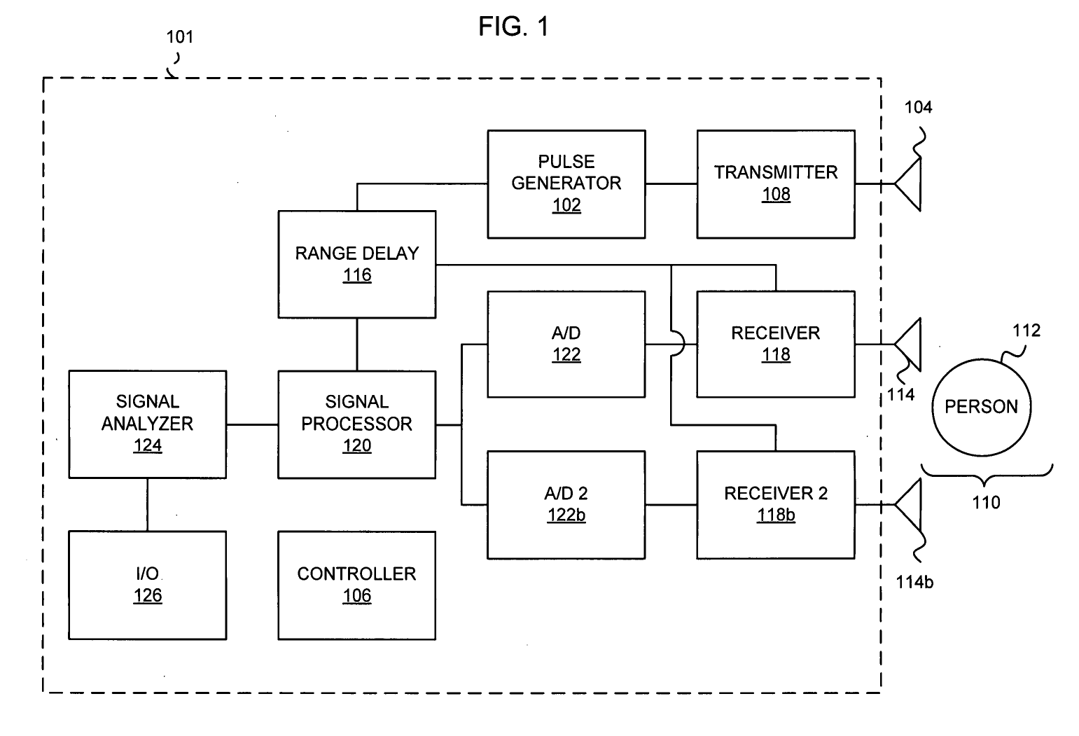

FIG. 1 is a simplified block diagram of a micro-impulse radar (MIR) 101, according to an embodiment. A pulse generator 102 is configured to output a relatively short voltage pulse that is applied to a transmit antenna 104. A typical transmitted pulse width can be between about two hundred picoseconds and about 5 nanoseconds, for example. The voltage pulse can be conditioned and amplified (or attenuated) for output by a transmitter 108. For example, the transmitter 108 can transmit the voltage pulse or can further condition the pulse, such as by differentiating a leading and/or trailing edge to produce a short sub-nanosecond transmitted pulses. The voltage pulse is typically not modulated onto a carrier frequency. Rather, the voltage pulse transmission spectrum is the frequency domain transform of the emitted pulse. The MIR 101 may probe a region 110 by emitting a series of spaced voltage pulses. For example, the series of voltage pulses can be spaced between about 100 nanoseconds and 100 microseconds apart. Typically, the pulse generator 102 emits the voltage pulses with non-uniform spacing such as random or pseudo-random spacing, although constant spacing can be used if interference or compliance is not a concern. Spacing between the series of voltage pulses can be varied responsive to detection of one or more persons 112 in the region 110. For example, the spacing between pulses can be relatively large when a person 112 is not detected in the region 112. Spacing between pulses may be decreased (responsive to one or more commands from a controller 106) when a person 112 is detected in the region 110. For example, the decreased time between pulses can result in faster MIR data generation for purposes of more quickly determining information about one or more persons 112 in the region 110. The emitted series of voltage pulses can be characterized by spectral components having high penetration that can pass through a range of materials and geometries in the region 110.

An object 112 (such as a person) in the probed region 110 can selectively reflect, refract, absorb, and/or otherwise scatter the emitted pulses. A return signal including a reflected, refracted, absorbed, and/or otherwise scattered signal can be received by a receive antenna 114. Optionally, the receive antenna 114 and transmit antenna 104 can be combined into a single antenna. In a single antenna embodiment, a filter (not shown) can be used to separate the return signal from the emitted pulse.

A probed region 110 may be defined according to an angular extent and distance from the transmit antenna 104 and the receive antenna 114. Distance can be determined by a range delay 116 configured to trigger a receiver 118 operatively coupled to the receive antenna 114. For example, the receiver 118 can include a voltage detector such as a capture-and-hold capacitor or network. The range delay corresponds to distance into the region 110. Range delay can be modulated to capture information corresponding to different distances.

A signal processor 120 can be configured to receive detection signals or data from the receiver 118 and the analog to digital converter 122, and by correlating range delay to the detection signal, extract data corresponding to the probed region 110 including the object 112.

Optionally, the MIR 101 can include a second receive antenna 114b. The second receive antenna can be operatively coupled to a second receiver 118b coupled to an output of the range delay 116 or a separate range delay (not shown) configured to provide a delay selected for a depth into the region 110. The signal processor 120 can further receive output from a second A/D converter 122b operatively coupled to the second receiver 118b.

The signal processor 120 can be configured to compare detection signals received by the antennas 114, 114b. For example, the signal processor 120 can search for common signal characteristics such as similar reflected static signal strength or spectrum, similar (or corresponding) Doppler shift, and/or common periodic motion components, and compare the respective range delays corresponding to detection by the respective antennas 114, 114b. Signals sharing one or more characteristics can be correlated to triangulate to a location of one or more objects 112 in the region 110 relative to known locations of the antennas 114, 114b. The triangulated locations can be output as computed ranges of angle or computed ranges of extent.

For example, a first signal corresponding to a reflected pulse received by an antenna element 114 can be digitized by an analog-to-digital converter (A/D) 122 to form a first digitized waveform. A second signal corresponding to the reflected pulse received by a second antenna element 114b can similarly be digitized by and A/D 122b (or alternatively by the same A/D converter 122) to form a second digitized waveform. The signal processor 120 can compare the first and second digitized waveforms and deduce angular information from the first and second digitized waveforms and known geometry of the first and second antenna elements.

A second pulse can be received at a second range delay 116 value and can be similarly signal processed to produce a second set of angular information that maps a second surface at a different distance. Depth within a given range delay can be inferred from a strength of the reflected signal. A greater number of signals can be combined to provide additional depth information. A series of pulses may be combined to form a time series of signals corresponding to the object 112 that includes movement information of the object 112 through the region 110. The object 112 described herein can include one or more persons.

The signal processor 120 outputs MIR data. The MIR data can include object location information, object shape information, object velocity information, information about inclusion of high density and/or conductive objects such as jewelry, cell phones, glasses including metal, etc., and physiological information related to periodic motion. The MIR data can include spatial information, time-domain motion information, and/or frequency domain information. Optionally, the MIR data may be output in the form of an image. MIR data in the form of an image can include a surface slice made of pixels or a volume made of voxels. Optionally, the image may include vector information.

The MIR data from the signal processor 120 is output to a signal analyzer 124. The signal analyzer 124 can be integrated with the signal processor 120 and/or can be included in the same MIR 101, as shown. Alternatively, the signal processor 120 can output MIR data through an interface to a signal analyzer 124 included in an apparatus separate from the MIR 101.

A signal analyzer 124 can be configured to extract desired information from MIR data received from the signal processor 120. Data corresponding to the extracted information can be saved in a memory for access by a data interface 126 or can be pushed out the data interface 126.

The signal analyzer 124 can be configured to determine the presence of a person 112 in the region 110. For example, MIR data from the signal processor can include data having a static spectrum at a location in the region 110, and a periodic motion spectrum corresponding to the location characteristic of a human physiological process (e.g. heartbeat and/or breathing). From the correspondence of such MIR data, it can be deduced that a person 112 is at the location in the region 110. The signal analyzer 124 can be configured to determine a number of persons 112 in the region 110. The signal analyzer 124 can be configured to determine the size of a person and/or relative size of anatomical features of a person 112 in the region 110. The signal analyzer 124 can be configured to determine the presence of an animal 112 in the region 110. The signal analyzer 124 can be configured to determine movement and/or speed of movement of a person 112 through the region 110. The signal analyzer 124 can be configured to determine or infer the orientation of a person 112 such as the direction a person is facing relative to the region 110. The signal analyzer 124 can be configured to determine one or more physiological aspects of a person 112 in the region 110. The signal analyzer 124 can determine presence of a personal appliance such as a cell phone, PDA, etc. and/or presence of metallized objects such as credit cards, smart cards, access cards, etc. The signal analyzer 124 may infer the gender and age of one or more persons based on returned MIR data. For example, male bodies may generally be characterized by higher mass density than female bodies, and thus can be characterized by somewhat greater reflectivity at a given range. Adult female bodies may exhibit relatively greater harmonic motion (“jiggle”) responsive to movements, and can thus be correlated to harmonic spectra characteristics. Older persons generally move differently than younger persons, allowing an age inference based on detected movement in the region 110.

By determination of one or more such aspects and/or combinations of aspects, the signal analyzer 124 can determine a demographic of one or more persons 112 in the region 110.

For example, MIR data can include movement corresponding to the beating heart of one or more persons 112 in the region 110. The signal analyzer 124 can filter the MIR data to remove information not corresponding to a range of heart rates, and determine one or more heart rates by comparing movement of the heart surface to the MIR signal rate. The one or more heart rates can further be characterized according to a confidence factor, depending on statistical certainty regarding the determined one or more heart rates.

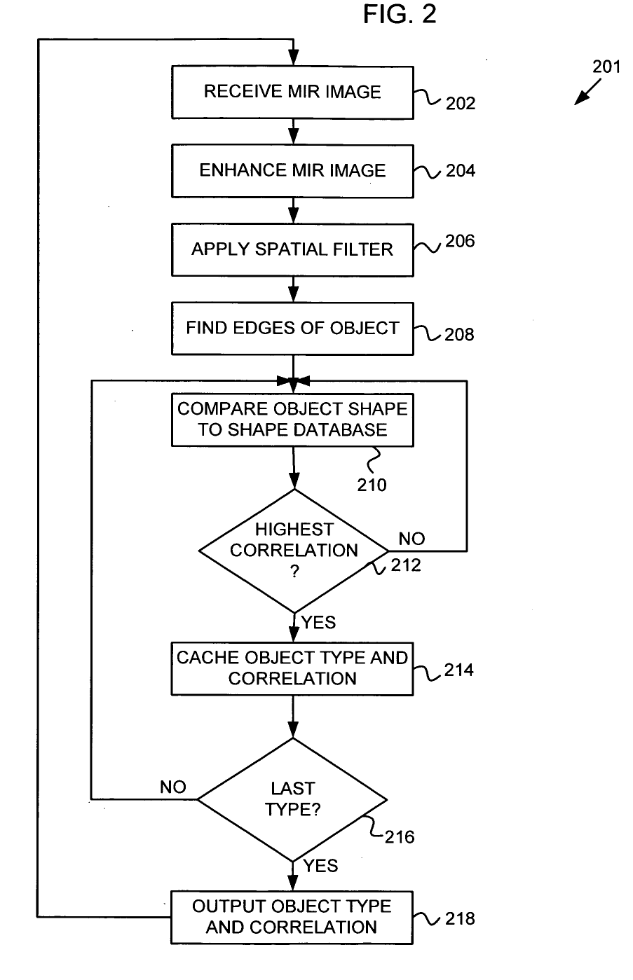

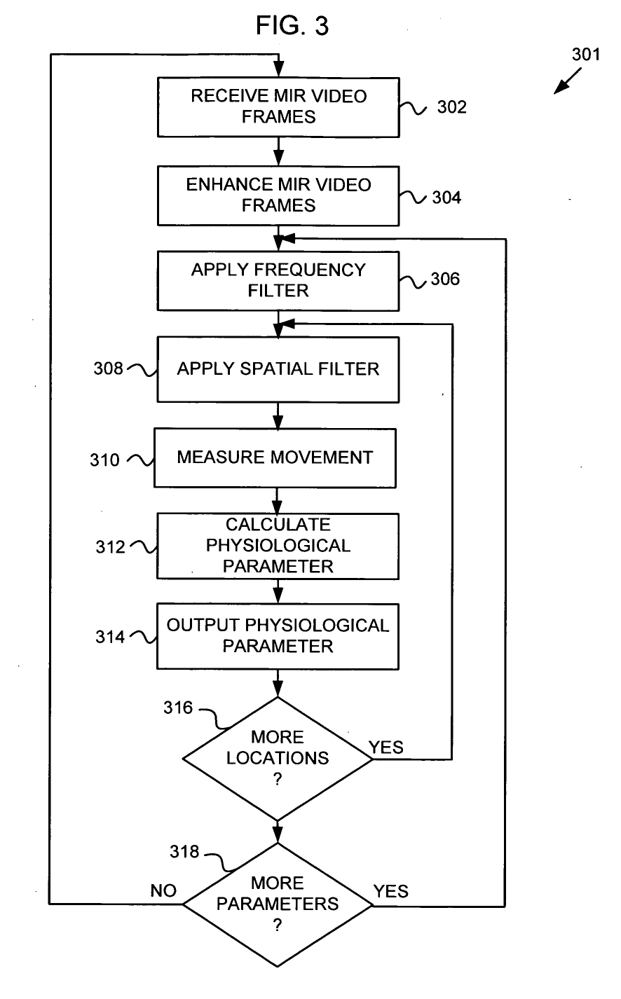

Similarly, the signal analyzer 124 can determine one or more respiration rates by measuring movement corresponding to the chest or diaphragm of one or more persons 112. The signal analyzer 124 can determine movement, a direction of movement, and/or a rate of movement of one or more persons 112 in the region 110. Operation of the signal analyzer 124 is described in greater detail below by reference to FIGS. 2 and 3.

An electronic controller 106 can be operatively coupled to the pulse generator 102, the transmitter 108, the range delay 116, the receiver 118, the analog-to-digital converter 122, the signal processor 120, and/or the signal analyzer 124 to control the operation of the components of the MIR 101. For embodiments so equipped, the electronic controller 106 can also be operatively coupled to the second receiver 118b, and the second analog-to-digital converter 122b. The data interface 126 can include a high speed interface configured to output of data from the signal analyzer 124. Alternatively, for cases where signals are analyzed externally to the MIR, the data interface 126 can include a high speed interface configured to output MIR data from the signal processor 120. The data interface 126 can include an interface to the controller 106. Optionally, the controller 106 may be interfaced to external systems via a separate interface (not shown).

FIG. 2 is a flow chart showing an illustrative process 201 for determining the presence of one or more persons 112 in the region 110 with the signal analyzer 124 of the MIR 101, according to an embodiment. Beginning with step 202, MIR data is received as described above in conjunction with FIG. 1. The MIR data can correspond to a plurality of probes of the region 110. Proceeding to optional step 204, the MIR data can be enhanced to facilitate processing. For example, grayscale data corresponding to static reflection strength as a function of triangulated position can be adjusted, compressed, quantized, and/or expanded to meet a desired average signal brightness and range. Additionally or alternatively, velocity information corresponding to Doppler shift, and/or frequency transform information corresponding to periodically varying velocity can similarly be adjusted, compressed, quantized, and/or expanded. Systematic, large scale variations in brightness can be balanced, such as to account for side-to-side variations in antenna coupling to the region. Contrast can be enhanced such as to amplify reflectance variations in the region.

Proceeding to optional step 206, a spatial filter can be applied. Application of a spatial filter can reduce processing time and/or capacity requirements for subsequent steps described below. The spatial filter may, for example, include a computed angle or computed extent filter configured to remove information corresponding to areas of contrast, velocity, or frequency component(s) having insufficient physical extent to be large enough to be an object of interest. The spatial filter may, for example, identify portions of the region 110 having sufficient physical extent to correspond to body parts or an entire body of a person 112, and remove features corresponding to smaller objects such as small animals, leaves of plants, or other clutter. According to an embodiment, the spatial filter can remove information corresponding to areas of contrast, velocity, or frequency component(s) having physical extent greater than a maximum angle or extent that is likely to correspond to a person or persons 112. In other embodiments, the spatial filter applied in step 206 can eliminate small, low contrast features, but retain small, high contrast features such as jewelry, since such body ornamentation may be useful in some subsequent processes. The step of applying the spatial filter 206 can further include removing background features from the MIR data. For example, a wall lying between an antenna 104, 114 and the region 110 can cast a shadow such as a line in every MIR signal. Removal of such constant features can reduce subsequent processing requirements.

Proceeding to optional step 208, an edge-finder can identify edges of objects 112 in the region 110. For example, a global threshold, local threshold, second derivative, or other algorithm can identify edge candidates. Object edges can be used, for example, to identify object shapes, and thus relieve subsequent processes from operating on grayscale data. Alternatively, step 208 may be omitted and the process of identifying objects may be performed on the grayscale MIR data.

Proceeding to step 210, processed data corresponding to the MIR data is compared to a database to determine a match. The object data received from step 202 (and optionally steps 204, 206, and/or 208) can be compared to corresponding data for known objects in a shape database. Step 210 can be performed on a grayscale signal, but for simplicity of description it will be assumed that optional step 208 was performed and matching is performed using object edges, velocity, and/or spectrum values. For example, the edge of an object 112 in the region 110 can include a line corresponding to the outline of the head and torso, cardiac spectrum, and movements characteristic of a young adult male. A first shape in the shape database may include the outline of the head and torso, cardiac spectrum, density, and movements characteristic of a young adult female and/or the head and torso outline, cardiac spectrum, density, and movements characteristic of a generic human. The differences between the MIR data and the shape database shape can be measured and characterized to derive a probability value. For example, a least-squares difference can be calculated.

Optionally, the object shape from the MIR data can be stepped across, magnified, and stepped up and down the shape database data to minimize a sum-of-squares difference between the MIR shape and the first shape in the shape database. The minimum difference corresponds to the probability value for the first shape.

Proceeding to step 212, if the probability value for the first shape is the best probability yet encountered, the process proceeds to step 214. For the first shape tested, the first probability value is the best probability yet encountered. If an earlier tested shape had a higher probability to the MIR data, the process loops back from step 212 to step 210 and the fit comparison is repeated for the next shape from the shape database.

In step 214, the object type for the compared shape from the shape database and the best probability value for the compared shape are temporarily stored for future comparison and/or output. For example, the compared shape from the shape database can be identified by metadata that is included in the database or embedded in the comparison data. Proceeding to step 216, the process either loops back to step 210 or proceeds to step 218, depending on whether a test is met. If the most recently compared shape is the last shape available for comparison, then the process proceeds to step 218. Optionally, if the most recently compared shape is the last shape that the process has time to compare (for example, if a new MIR data is received and/or if another process requires output data from the process 201) then the process proceeds to step 218. In step 218, the object type and the probability value is output. The process can then loop back to step 202 and the process 201 can be repeated.

Otherwise, the process 201 loops from step 216 back to step 210. Again, in step 210, the next comparison shape from a shape database is loaded. According to an embodiment, the comparison can proceed from the last tested shape in the shape database. In this way, if the step 218 to 202 loop occurs more rapidly than all objects in the shape database can be compared, the process eventually works its way through the entire shape database. According to an embodiment, the shape database can include multiple copies of the same object at different orientations, distances, and positions within the region. This can be useful to reduce processing associated with stepping the MIR shape across the shape database shape and/or changing magnification.

The object type may include determination of a number of persons 112 in the region 110. For example, the shape database can include outlines, cardiac and/or respiration spectra, density, and movement characteristics for plural numbers of persons. According to embodiments, the shape library can include shapes not corresponding to persons. This can aid in identification of circumstances where no person 212 is in the region 210. Optionally, process 201 can be performed using plural video frames such as averaged video frames or a series of video frames. Optionally, steps 212, 214, and 216 can be replaced by a single decision step that compares the probability to a predetermined value and proceeds to step 218 if the probability meets the predetermined value. This can be useful, for example, in embodiments where simple presence or absence of a person 212 in the region 210 is sufficient information.

According to an embodiment, the signal analysis process 201 of FIG. 2 can be performed using conventional software running on a general-purpose microprocessor. Optionally, the process 201 using various combinations of hardware, firmware, and software and can include use of a digital signal processor.

FIG. 3 is a flow chart showing an illustrative process 301 for determining one or more particular physiological parameters of a person 112 in the region 110 with the signal analyzer 124 of the MIR 101, according to an embodiment. Optionally, the process 301 of FIG. 3 can be performed conditional to the results of another process such as the process 201 of FIG. 2. For example, if the process 201 determines that no person 112 is in the region 110, then it can be preferable to continue to repeat process 201 rather than execute process 301 in an attempt to extract one or more particular physiological parameters from a person that is not present.

Beginning with step 302, a series of MIR time series data is received. While the received time series data need not be purely sequential, the process 301 generally needs the time series data received in step 302 to have a temporal capture relationship appropriate for extracting time-based information. According to an embodiment, the MIR time series data can have a frame rate between about 16 frames per second and about 120 frames per second. Higher capture rate systems can benefit from depopulating frames, such as by dropping every other frame, to reduce data processing capacity requirements.

Proceeding to step 304, the MIR video frames can be enhanced in a manner akin to that described in conjunction with step 204 of FIG. 2. Optionally, step 304 can include averaging and/or smoothing across multiple MIR time series data. Proceeding to optional step 306, a frequency filter can be applied. The frequency filter can operate by comparing changes between MIR time series data to a reference frequency band for extracting a desired physical parameter. For example, if a desired physiological parameter is a heart rate, then it can be useful to apply a pass band for periodic movements having a frequency between about 20 cycles per minute and about 200 cycles per minute, since periodic motion beyond those limits is unlikely to be related to a human heart rate. Alternatively, step 304 can include a high pass filter that removes periodic motion below a predetermined limit, but retains higher frequency information that can be useful for determining atypical physiological parameters.

Proceeding to optional step 308, a spatial filter can be applied. The spatial filter may, for example, include a pass band filter configured to remove information corresponding to areas of contrast having insufficient physical extent to be large enough to be an object of interest, and remove information corresponding to areas too large to be an object of interest. The spatial filter may, for example, identify portions of the region 110 having sufficient physical extent to correspond to the heart, diaphragm, or chest of a person 112, and remove signal features corresponding to smaller or larger objects. The step of applying the spatial filter 308 can further include removing background features from the MIR data. For example, a wall lying between an antenna 104, 114 (114b) and the region 110 can cast a shadow such as a line in every instance of MIR data. Removal of such constant features can reduce subsequent processing requirements.

Proceeding to step 310, movement such as periodic movement in the MIR time series data is measured. For example, when a periodic motion is to be measured, a time-to-frequency domain transform can be performed on selected signal elements. For example, when a non-periodic motion such as translation or rotation is to be measured, a rate of movement of selected signal elements can be determined. Optionally, periodic and/or non-periodic motion can be measured in space vs. time. Arrhythmic movement features can be measured as spread in frequency domain bright points or can be determined as motion vs. time. Optionally, subsets of the selected signal elements can be analyzed for arrhythmic features. Optionally, plural subsets of selected signal elements can be cross-correlated for periodic and/or arrhythmic features. Optionally, one or more motion phase relationships between plural subsets of selected signal features, between a subset of a selected signal feature and the signal feature, or between signal features can be determined. For example, a person with a hiccup may be detected as a non-periodic or arrhythmic motion superimposed over periodic motion of a signal element corresponding to the diaphragm of the person.

Proceeding to step 312, a physiological parameter can be calculated. For example, MIR data can include data having a periodic motion spectrum corresponding to the location characteristic of a human physiological process (e.g. heartbeat and/or breathing). Step 312 can include determining one or more heart rates by comparing movement of the heart surface to the MIR signal rate. The one or more heart rates can further be characterized according to a confidence factor, depending on statistical certainty regarding the determined one or more heart rates. Similarly, step 312 can include determining one or more respiration rates by measuring movement corresponding to the chest or diaphragm of one or more persons.

Proceeding to step 314, the physiological parameter can be output. Proceeding to step 316, if there are more locations to measure, the process 301 can loop back to execute step 308. If there are not more locations to measure, the process can proceed to step 318. In step 318, if there are more physiological parameters to measure, the process 301 can loop back to execute step 306. If there are not more physiological parameters to measure, the process 301 can loop back to step 302, and the process 301 of FIG. 3 can be repeated.

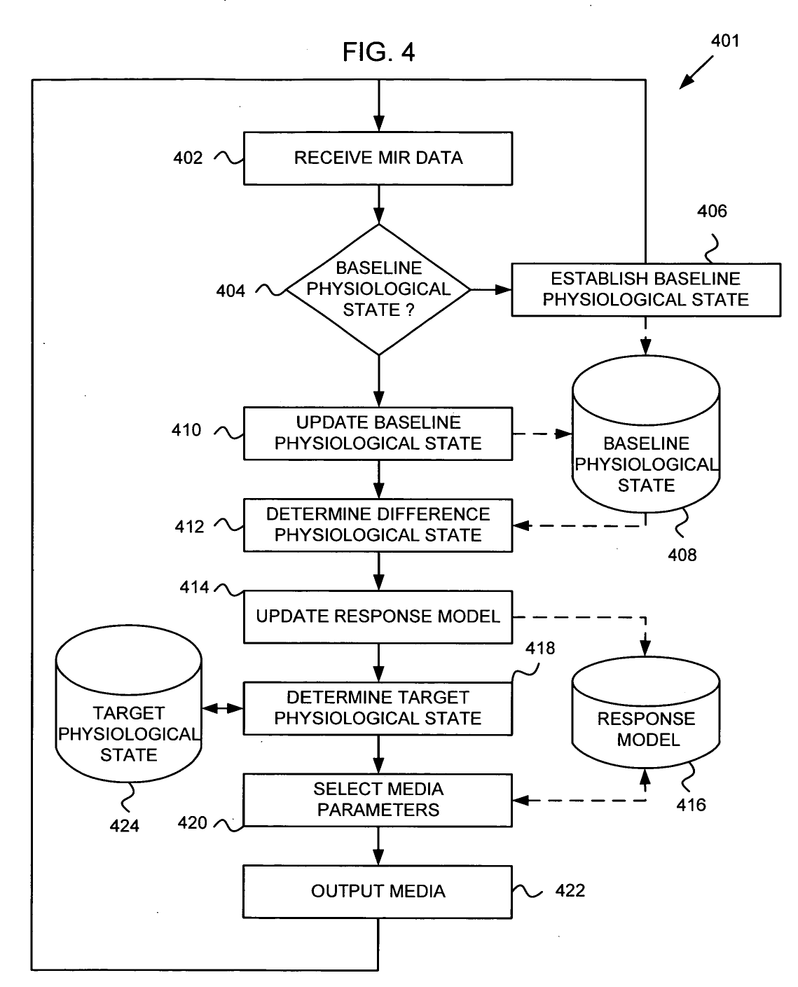

FIG. 4 is a flow chart showing an illustrative process 401 for selecting at least one media parameter for media output to at least one person 112, according to an embodiment. In step 402, MIR data corresponding to a region is received, the MIR data including information associated with a first physiological state corresponding to a person in the region. For example, the first physiological state can include at least one of heart rate, respiration rate, heart anomaly, respiration anomaly, magnitude of heartbeat, magnitude of respiration, speed or magnitude of inhalation (such as may be associated with a wheeze), speed or magnitude of exhalation (such as may be associated with a cough), intracyclic characteristic of a heartbeat, intracyclic characteristic of respiration, muscle tremor (such as may be associated with a shiver or with a fight-or-flight response), body hydration, or digestive muscle activity. The person may include a plurality of persons.

Terminology related to outputting a media stream is used herein. Outputting a media stream shall be interpreted as outputting media from a media player. Such media output can be a stream, as in data that generally cannot be saved at a client computer system. But such media output can also involve a transfer of media files that can be saved. Accordingly, the term media stream relates to a continuous or discontinuous output of media to one or more persons.

Receiving MIR data can further include transmitting electromagnetic pulses toward the region, delaying the pulses in a pulse delay gate, synchronizing a receiver to the delayed pulses, receiving electromagnetic energy scattered from the pulses, and outputting a received signal. Receiving MIR data can further include performing signal processing on the received signal to extract one or more Doppler signals corresponding to human physiological processes, performing signal analysis on the one or more Doppler signals to extract data including information associated with the first physiological state corresponding to the person in the region, and outputting the MIR data including the information associated with the first physiological state.

The MIR data may include a MIR image. For example, the MIR image can include a planar image including pixels, a volumetric image including voxels, or a vector image. The MIR data can further include information related to posture, location of the person in the region, body movements of the person, movement of the person through the region, the speed of movement of the person, a direction the person is facing, physical characteristics of the person, number of persons in the region, or a physical relationship between two or more persons in the regions. Such additional information can also be useful for selecting media parameters.

The first physiological state can correspond to an emotional state. The emotional state can be inferred as a function of a physiological state correspondence to an autonomic nervous system state of the person. The autonomic nervous system may indicate a sympathetic or a parasympathetic response relative to an earlier corresponding physiological state. For example, a sympathetic response of the autonomic nervous system of the person may be exhibited, relative to an earlier observed autonomic nervous system state of the person, as an increase in heart rate, an increase in respiration rate, an increase in tremor, and/or a decrease in digestive muscle activity. Similarly, a parasympathetic response of the autonomic nervous system of the person may be exhibited, relative to an earlier observed autonomic nervous system state of the person, as a decrease in heart rate, a decrease in respiration rate, a decrease in tremor, and/or an increase in digestive muscle activity.

Proceeding to step 420 (intervening optional steps will be described more fully below), one or more media parameters are selected responsive to the first physiological state. For example, in embodiments where an emotional state is inferred from the first physiological state, selection of one or more media parameters can be made corresponding to the inferred emotional state. For example, the media parameters can be selected to urge the person toward a desired or target emotional state.

For example, one or more media parameters may include parameters for outputting the media stream to the region, stopping output of the media stream to the region, or stopping output of one media stream to the region and starting output of another media stream to the region.

A complication in inferring an emotional state relates to a systematic difference between men and women in the way reported emotions correspond to measured physiological effects of the respective autonomic nervous systems. Accordingly selecting at least one media parameter can include determining a gender of the person from the micro-impulse radar data, and inferring an emotional change as a function of a change in the state of the autonomic nervous system and the gender. For example, inferring an emotional change as a function of a change in the state of the autonomic nervous system and gender can include inferring a relatively small change in emotional state compared to the change in autonomic nervous system state if the gender is male. Alternatively, inferring an emotional change as a function of a change in the state of the autonomic nervous system and gender can include inferring a relatively large change in emotional state compared to the change in autonomic nervous system state if the gender is female.

A range of media parameters may be selected. For example, the selected media parameter can include media content. According to other examples, the media parameter can include one or more of media delivery modality, media delivery device selection, a musical beat frequency, an audio volume, an audio balance, an audio channel separation, an audio equalization, an audio resolution, a dynamic range, a language selection, a video brightness, a video color balance, a video contrast, a video sharpness, a video resolution, a video zoom, a video magnification, a playlist, an artist, a genre, an advertising product or service category, an advertising content expansion, a game content, a game logic, a game control input, or a haptic output.

Proceeding to step 422, media corresponding to one or more parameters selected in step 420 is output to the person. For example, the media output can include a media stream. Outputting a media stream can include outputting one or more of video media, audio media, image media, text, haptic media, an advertisement, entertainment, news, data, software, or information.

As implied above, it can be useful to determine a relative physiological state of a person, and select media parameters based on the relative states. One reason for this is that, according to embodiments, we are interested in providing media to a person to effect a change in physiological (and optionally, emotional) state. By comparing a first physiological state to one or more earlier physiological states, a system can determine the affect the media output has on the person. For example, if a person arrives in the region distraught, and media output begins to calm the person, the calming effect can be monitored by comparing a series of first physiological states (e.g. current physiological states) against the initial physiological state (or a function of earlier physiological states). In contrast, if the first physiological state was not compared against the initial physiological state, the information in the MIR data can continue to indicate a physiological state corresponding to “distraught”, and not recognize the calming effect that the media output is having on the person.

Referring again to step 402, the process 401 can optionally proceed to step 404. In step 404, the control system determines if a baseline physiological state has been established for the person. If no baseline physiological state is in memory (or storage), the process proceeds to step 406, where the system establishes a baseline physiological state 408. For example, the baseline physiological state 408 can correspond to the initial physiological state determined when the person first entered the MIR-probed region.

Optionally, a baseline physiological state can correspond to a state of the person when no media stream is presented to the person or to a state when one or more previous media stream(s) was presented to the person. Alternatively, the baseline physiological state can be provided to the control system from an external resource. For example, the control system may query a database to retrieve the baseline physiological state.

If, in step 404, it is determined that a baseline physiological state has been established, the process can proceed to optional step 410. In optional step 410, the baseline physiological state 408 can be updated. For example, if the baseline physiological state corresponds to a physiological state determined substantially when the person entered the region, then step 410 can be omitted. According to another embodiment, the baseline physiological state can correspond to a function of previously determined physiological states. For example, the baseline physiological state can correspond to a median, mean, or mode of previously determined physiological states. In such cases, step 410 can include calculating a function of the current physiological state and previous physiological states that is literally the median, mean, or mode; or a function that corresponds to a statistical function. For example, the baseline physiological state can be calculated as a sum of weighted values of one or more physiological parameters previously received and optionally corresponding one or more physiological parameters of the first physiological state.

Proceeding to step 412, a difference physiological state is determined. The difference physiological state corresponds to a change from the baseline physiological state to the first physiological state.

Proceeding to step 420, one or more media parameters can be selected responsive to the difference physiological state.

Optionally, the effect that media output has on the person may be tracked to determine a response model 416, and the response model can be used to inform selection of the one or more media parameters. For example, operating a system using a response model 416 can include, in step 420, recording one or more media parameters selected; outputting the media in step 422, and then, in the next loop at step 414, recording the physiological state or the difference physiological state of the person during or after output of the media. In this way, steps 414 and 420 can be characterized as recording physiological states and temporally corresponding selected one or more media parameters, and receiving, selecting, or inferring a physiological response model from the recorded physiological states and corresponding media parameters. Accordingly, in step 420 selecting one or more media parameters responsive to the first physiological state can include selecting the one or more media parameters responsive to the physiological response model 416.

Receiving, selecting, or inferring a physiological response model can include generating a physiological response model for the person. Alternatively, the physiological states and temporally corresponding one or more media parameters can be matched to previous response models, such as by selecting a best match from a library of physiological response models. Alternatively, the physiological states and temporally corresponding one or more media parameters can be transmitted to an external resource and a physiological response model received from the external resource or an operatively coupled second external resource. These and additional alternative approaches are referred to herein as inferring a physiological response model. Similar approaches can be used to determine a target physiological state.

Optionally, the process 401 can include step 418, wherein a target physiological state 424 is determined. Optionally, the target physiological state 424 can be predetermined, such as, for example, maintaining the person's heart rate at or below a maximum heart rate. According to an embodiment, step 418 can include establishing a target attribute, action or response of a person; detecting the attribute, action, or response corresponding to the person in the region; recording physiological states and temporally corresponding attributes, actions, or responses; and receiving, selecting, or inferring a target physiological state from the recorded physiological states and temporally corresponding attributes, actions, or responses. In combination with the response model 416 and step 418, step 420 can thus include selecting one or more media parameters having a likelihood of inducing the person to meet or maintain the target physiological state.

According to an embodiment of step 418, the detected attribute, action, or response can be detected by the MIR. The MIR data can further include spatial information corresponding to the person, and selecting the media parameter can include selecting the media parameter corresponding to the spatial information. For example, as described above, the MIR data can further include information related to posture, location of the person in the region, body movements of the person, movement of the person through the region, a direction the person is facing, physical characteristics of the person, posture, number of persons in the region, or a physical relationship between two or more persons in the regions. One or more such relationships can comprise or be included in a desired attribute, action, or response corresponding to the person in the region.

Alternatively or additionally, the detected attribute, action, or response can be received through a data interface or detected by a sensor separate from the MIR. According to embodiments, the attribute, action, or response of the person can be detected by a video camera, can be detected by a microphone, can be a result of analysis of operation of controls by the person, detected by a motion sensor worn or carried by the person, or can include a response using a touch screen, button, keyboard, or computer pointer device.

Accordingly, the process 401 can include receiving second data from a sensor or source other than the MIR and also, in step 420, selecting the one or more media parameters responsive to the second data. The second data can include one or more of a time, a day, a date, a temperature, a humidity, a location, an ambient sound level, an ambient light level, or a video image. For example, the second data can include a facial expression. The process 401 can then include determining a correlation or non-correlation of the facial expression to the first physiological state. Selecting one or more media parameters in step 420 can include selecting the one or more media parameters as a function of the correlation or the non-correlation.

According to embodiments, the target attribute, action, or response; and the corresponding target physiological state can correspond to performance of one or more tasks, responsiveness to a stimulus, alertness, sleep, or calmness. Alternatively or additionally, the target attribute, action or response; and corresponding the target physiological state can correspond to responsiveness of the person to content of the media stream.

For example, the first physiological state can include a physiological state corresponding to wakefulness or sleepiness, and selecting the media parameter(s) can include selecting a media parameter to induce sleep or wakefulness. In another example, the first physiological state can include a physiological state corresponding to exercise, and selecting the media parameter can include selecting a media parameter to pace the exercise. In another example, the first physiological state can include a physiological state corresponding to agitation, and selecting the media parameter can include selecting a media parameter to induce a calming effect in the person. In another example, the first physiological state can include a physiological state corresponding to a meditative state, and selecting the media parameter can include selecting a media parameter to induce a desired progression in the meditative state of the person.

According to another example, the first physiological state can include a physiological state corresponding to attentiveness, and selecting the media parameter can include selecting a media parameter to responsive to the attentiveness of the person. For example, selecting media content responsive to the attentiveness of the person can include selecting an advertising message responsive to the attentiveness of the person. Selecting at least one media parameter can include selecting at least one media parameter corresponding to making the media more prominent when the physiological state corresponds to attentiveness to the media output. For example, a media parameter to make the media output more prominent can include one or more of louder volume audio, greater dynamic range audio, higher brightness, contrast, or color saturation video, higher resolution, content having higher information density or more appealing subject matter, or added haptic feedback. Similarly, selecting at least one media parameter can include selecting at least one media parameter corresponding to making the media less prominent when the physiological state corresponds to inattentiveness to the media output. For example, a media parameter to make the media output less prominent can include one or more of quieter volume audio, reduced dynamic range audio, reduced brightness, contrast, or color saturation video, lower resolution, content having lower information density or less appealing subject matter, or reduced haptic feedback. According to other embodiments, the media parameter may include control of 3D versus 2D display, 3D depth setting, gameplay speed, and/or data display rate.

As may be appreciated, selecting one or more media parameters responsive to the first physiological state can include selecting the one or more media parameters as a function of a time history of MIR data. Looking at the looping behavior of the process 401, after at least beginning step 422, the process loops back to step 402, where second MIR data corresponding to a region can be received, the second MIR data including information associated with a second physiological state corresponding to a person in the region. Proceeding to step 412, the first physiological state can be compared to the second physiological state. Proceeding to step 420, one or more of the media parameters can be modified responsive to the comparison between the first and second physiological states. As described above, the MIR data can further include spatial information corresponding to the person. Accordingly, step 412 can include comparing first spatial information corresponding to the first physiological state to second spatial information corresponding to the second physiological state. In step 420, modifying one or more of the media parameters can thus include modifying one or more of the media parameters responsive to the comparison between the first and second spatial information.

The method described in conjunction with FIG. 4 can be physically embodied as computer executable instructions carried by a tangible computer readable medium.

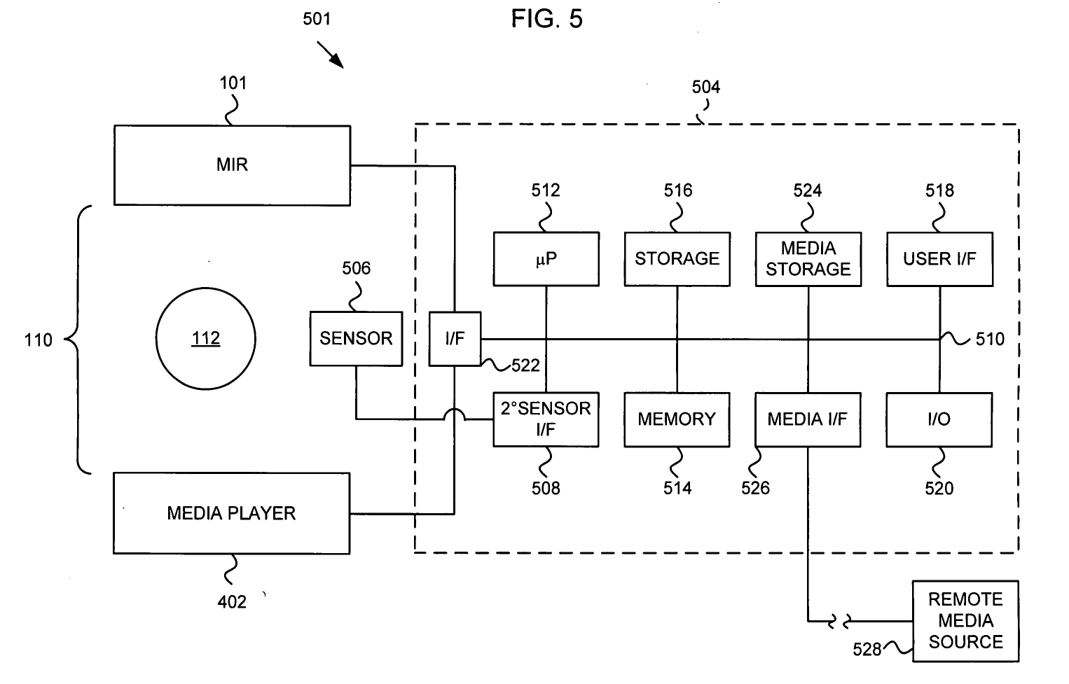

FIG. 5 is a block diagram of a system 501 for providing a media stream to a person 112 responsive to a physiological response of the person, according to an embodiment. For example, the system 501 can operate according to one or more processes described in conjunction with FIG. 4, above.

The system 501 includes a MIR system 101 configured to detect, in a region 110, a first physiological state associated with a person 112, and a media player 502 operatively coupled to the MIR system 101 and configured to play media to the region 110 responsive to the detected first physiological state associated with the person 112. For example, the first physiological state can include heart rate, respiration rate, heart anomaly, respiration anomaly, magnitude of heartbeat, magnitude of respiration, speed or magnitude of inhalation, speed or magnitude of exhalation, intracyclic characteristic of a heartbeat, intracyclic characteristic of respiration, tremor, and/or digestive muscle activity. For example, the media player 502 can be configured to output video media, audio media, image media, text, haptic media, an advertisement, entertainment, news, data, software, and/or information to the person 112.

Referring to FIG. 1, The MIR system 101 can include a transmitter 108 configured to transmit electromagnetic pulses toward the region 110, a pulse delay gate 116 configured to delay the pulses, and a receiver 118 synchronized to the pulse delay gate and configured to receive electromagnetic energy scattered from the pulses. A signal processor 120 can be configured to receive signals or data from the receiver 118 and to perform signal processing on the signals or data to extract one or more Doppler signals corresponding to human physiological processes. A signal analyzer 124 can be configured to receive signals or data from the signal processor 120 and to perform signal analysis to extract, from the one or more Doppler signals, data including information associated with the first physiological state corresponding to the person 112 in the region 110. An interface 126 operatively coupled to the signal analyzer 124 can be configured to output MIR data including the information associated with the first physiological state.

The MIR system 101 can be configured to output MIR data including the first physiological state associated with the person 112. According to an embodiment, the MIR data can include a MIR image, such as a planar image including pixels, a volumetric image including voxels, and/or a vector image.

The system 501 can further include a controller 504 operatively coupled to the MIR system 101 and the media player 502. The media controller 504 can be configured to select one or more media parameters responsive to the first physiological state. According to an embodiment, at least a portion of the MIR system 101 can be integrated into the controller 504. The media player 502 can be integrated into the controller 504. Optionally, the controller 504 can be integrated in to the media player 502. The controller 504 can further include at least one sensor 506 and/or sensor interface 508 configured to sense or receive second data corresponding to the environment of the region 110. The controller 504 can also be configured to select the one or more media parameters responsive to the second data corresponding to the environment of the region 110. For example, the second data can include one or more of a time, a day, a date, a temperature, a humidity, a location, an ambient sound level, an ambient light level, or a video image.

The controller 504 can be based on a general-purpose computer or can be based on a proprietary design. Generally, either such platform can include, operatively coupled to one another and to the MIR 101, the media player 502, and the sensor 106 and/or sensor interface 508 via one or more computer buses 510, a computer processor 512, computer memory 514, computer storage 516, a user interface 518, and (generally a plurality of) data interface(s) 520. The MIR system 101 and/or the media player 502 can be operatively coupled to the controller 504 through one or more interfaces 522. The controller 504 can be located near the MIR system 101 and the media player 502, or optionally can be located remotely.

The computer processor 512 may, for example, include a CISC or RISC microprocessor, a plurality of microprocessors, one or more digital signal processors, gate arrays, field-programmable gate arrays, application specific integrated circuits such as a custom or standard cell ASIC, programmable array logic devices, generic array logic devices, co-processors, fuzzy logic processors, and/or other devices. The computer memory 512 may, for example, include one or more contiguous or non-contiguous memory devices such as random access memory, dynamic random access memory, static random access memory, read-only memory, programmable read-only memory, electronically erasable programmable read only memory, flash memory, and/or other devices. Computer storage 516 may, for example, include rotating magnetic storage, rotating optical storage, solid state storage such as flash memory, and/or other devices. Functions of computer memory 514 and computer storage 516 can be interchangeable, such as when some or all of the memory 514 and storage 516 are configured as solid state devices, including, optionally, designated portions of a contiguous solid state device. The user interface 518 can be detachable or omitted, such as in unattended applications that automatically play media to a user 112. The user interface 518 can be vestigial, such as when the system 501 is configured as an alarm clock, and the user controls are limited to clock functions. The user interface 518 can include a keyboard and computer pointer device and a computer monitor. Alternatively, the MIR 101, sensor 506, and/or media player 502 can form all or portions of the user interface and a separate user interface 518 can be omitted. The data interface 520 can include one or more standard interfaces such as USB, IEEE 802.11X, a modem, Ethernet, etc.

The controller 504 can also include media storage 524 configured to store media files or media output primitives configured to be synthesized to media output by the processor 512. Media content stored in the media storage 524 can be output to the media player 502 according to media parameters selected as described herein. Optionally, the media storage 524 can be integrated into the controller storage 516.

The controller 504 can optionally include a media interface 526 configured to receive media from a remote media source 528. A remote media source can include, for example, a satellite or cable television system, a portable media player carried by the person 112, a media server, one or more over-the-air radio or television broadcast stations, and/or other content source(s). Optionally, the media interface 526 can be combined with the data interface 520. Optionally, the media storage 524 and/or the media interface 526 can be located remotely from the controller 504.

According to an embodiment, the controller 504 is further configured to drive the media player 502 to output media to the region 112 according to the selected one or more media parameters. Such one or more media parameters can include media content, media delivery modality, media delivery device selection, a musical beat frequency, an audio volume, an audio balance, an audio channel separation, an audio equalization, an audio resolution, a dynamic range, a language selection, a video brightness, a video color balance, a video contrast, a video sharpness, a video resolution, a video zoom, a video magnification, a playlist, an artist, a genre, an advertising product or service category, an advertising content expansion, a game content, a game logic, a game control input, and/or a haptic output.

Optionally, the controller 504 can be configured to establish a baseline physiological state and determine a difference physiological state corresponding to a difference between the baseline physiological state and the first physiological state detected by the MIR system 101. The controller 504 can select the one or more media parameters responsive to the difference physiological state. For example, the controller can be configured to determine, using MIR data from the MIR system 101, a first physiological state corresponding to the time the person enters the region, and store in a computer memory device 514, 516 a baseline physiological state corresponding to the first physiological state determined substantially when the person entered the region.

Alternatively or additionally, the controller 504 in conjunction with the MIR system 101 can be configured to determine a first physiological state corresponding the person 112 in the region 110, read a baseline physiological state for the person from a computer memory device 514, 516, compare the first physiological state to the baseline physiological state, and, if the first physiological state includes a heart rate, a breathing rate, or a heart rate and breathing rate lower that a heart rate, a breathing rate, or a heart rate and a breathing rate included in the baseline physiological state, replace the baseline physiological state with the first physiological state to make the baseline physiological state correspond to a minimum detected heart rate, breathing rate, or heart rate and breathing rate corresponding to the person 112.

Alternatively or additionally, the controller 504 in conjunction with the MIR system 101 can be configured to determine a first physiological state corresponding the person 112 in the region 110, combine the first physiological state with at least one previously read physiological states or a function of a plurality previously read physiological states to determine a baseline physiological state that is a function of the first physiological state and one or more previously read physiological states, and store at least one of the baseline physiological state, the first physiological state, or the function of the first physiological and one or more previously read physiological states in a computer memory device 514, 516. For example, combining the first physiological state with at least one previously read physiological state or a function of a plurality of previously read physiological states can include calculating a function corresponding to a median, mean, or mode of the first and previous physiological states. For example, the function corresponding to a media, mean, or mode of the first and previous physiological states can include a median, mean, and/or mode of heart rate, breathing rate, or heart rate and breathing rate corresponding to the person 112.

Optionally, the controller can be configured to store a record of detected physiological states in computer memory 514 or storage 516 as a function of time and store a record of selected one or more media parameters in computer memory 514 or storage 516 (or in the media storage 524 or remotely through media interface 526) as a function of time. The controller 504 can infer a physiological response model from the tracked physiological states and corresponding media parameters. The physiological response model can be stored in the computer memory 514 or storage 516. Accordingly, the controller 504 can apply the physiological response model to select one or more media parameters.

Optionally, the controller 504 can be configured to establish a target physiological state select one or more media parameters having a likelihood of meeting or maintaining the target physiological state. For example, the controller 504 can measure productivity of the person through the data interface 508 and/or sensor 506 different from the micro-impulse radar 101, and establish in memory 514, 516 a target physiological state as a function of the productivity of the person 112 correlated to the first physiological state. According to another embodiment, the controller 502 can include a data interface 508 or sensor 506 different from the MIR 101 configured to detect a stimulus received by the person 112. The MIR 101 or another data interface 508 or sensor 506 can be configured to detect a response of the person 112 to the stimulus. The controller 504 can be configured to establish a target physiological state in memory 514, 516 as a function of the response of the person 112 to the stimulus correlated to the first physiological state.

For example, the target physiological state may correspond to high productivity performing one or more tasks, alertness, interest in media content, an emotional state, wakefulness, sleep, calmness, exercise activity, a pace of exercise, a meditative state, attentiveness, and/or responsiveness to an advertising message corresponding to the person 112.

According to an embodiment, the MIR 101 can be configured to detect spatial information, and the media player 502 can be configured to play media to the region 110 responsive to both the detected first physiological state associated with the person 112 and the spatial information. For example, the spatial information can include information related to posture, a location of the person 112 in the region 110, body movements of the person 112, movement of the person 112 through the region 110, a direction the person 112 is facing, physical characteristics of the person 112, number of persons 112 in the region, a physical relationship between two or more persons 112 in the region, and/or gender of the person 112.

The media player 502 can be configured to play media to the region 110 corresponding to one or more media parameters selected responsive to the detected first physiological state associated with the person 112. According to an embodiment, the first physiological state can correspond to attentiveness of the person 112 to the media output from the media player 502. In response, the at least one media parameter can be selected to make the media output by the media player 502 more prominent. For example, the at least one media parameter to make the media output more prominent can include louder volume audio, greater dynamic range audio, higher brightness video, higher contrast video, higher color saturation video, higher resolution, content having higher information density, content having more appealing subject matter, and/or added haptic feedback.

According to another embodiment, the first physiological state of the person 112 can correspond to inattentiveness to the media output. Responsively, the at least one media parameter can be selected to make the media output less prominent. For example, the at least one media parameter to make the media output less prominent can include quieter volume audio, reduced dynamic range audio, reduced brightness video, reduced contrast video, reduced color saturation video, lower resolution, content having lower information density, content having less appealing subject matter, and/or reduced haptic feedback.

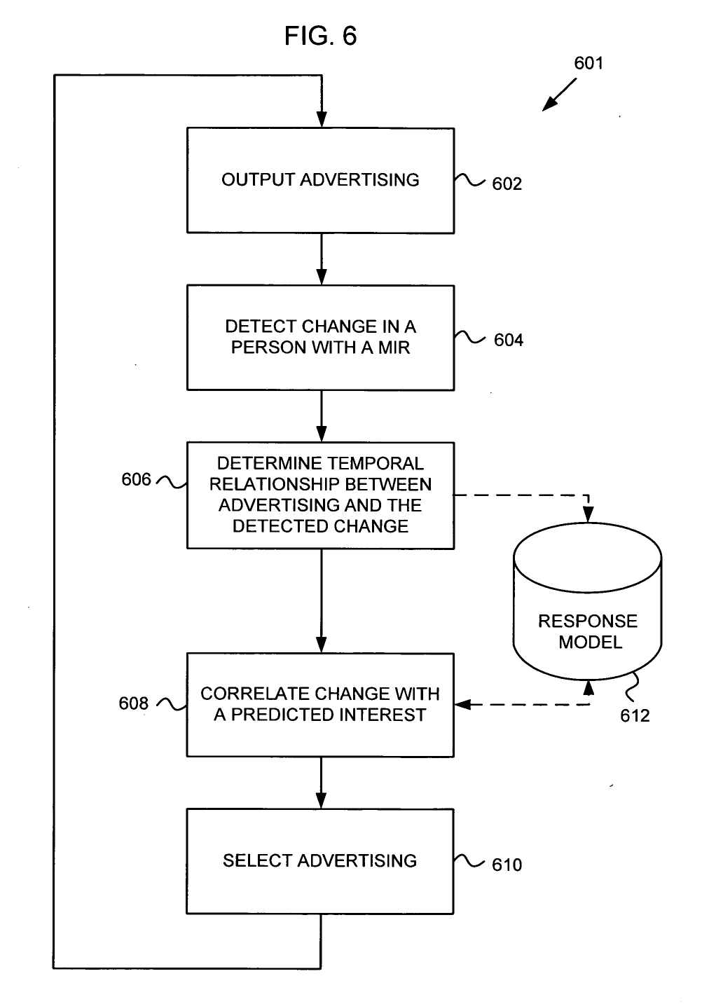

FIG. 6 is a flow chart showing an illustrative process 601 for targeting electronic advertising, according to an embodiment. Beginning at step 602, electronic advertising content is output to a person. The electronic advertising content may be referred to as first electronic advertising content during a loop through the process 601. The at least one first electronic advertising content can include content corresponding to an advertiser, a product genre, a service genre, a production style, a price, a quantity, sales terms, lease terms, and/or a target demographic.

Proceeding to step 604, at least one physiological or physical change is detected in a person exposed to the first electronic advertising content with a MIR. A physical change detected by the MIR can include a change in posture, a change in location within the region, a change in direction faced, movement toward the media player, movement away from the media player, a decrease in body movements, an increase in body movements, and/or a change in a periodicity of movement.

A physiological response may include a physiological response corresponding to a sympathetic response of the person's autonomic nervous system. A sympathetic response may include one or more of an increase in heart rate, an increase in breathing rate, and/or a decrease in digestive muscle movements. Alternatively, the physiological response may include a physiological response corresponding to a parasympathetic response of the person's autonomic nervous system. A parasympathetic response may include one or more of a decrease in heart rate, a decrease in breathing rate, and/or an increase in digestive muscle movements.

Proceeding to step 608 (step 606 will be described below), the at least one physiological or physical change in the person is correlated with a predicted degree of interest in the first electronic advertising content. For example, correlating the at least one physiological or physical change in the person with a predicted degree of interest in the first electronic advertising content can include correlating the at least one physiological and/or physical change to one or more of the advertiser, the product genre, the service genre, the production style, the price, the quantity, the sales terms, the lease terms, and/or the target demographic. Correlating the change in a person with a predicted degree of interest can include inferring a demographic.

Proceeding to step 610, second electronic advertising is selected. The second electronic advertising is selected corresponding to a predicted degree of interest.

Looping back to step 602, the second electronic advertising is output responsive to the predicted degree of interest in the first electronic advertising content.

Viewing the process 601 as including a plurality of loops, it may be seen that references to first and second advertising content may be used interchangeably, depending on context. First electronic advertising content can moreover correspond to any electronic advertising content previously output. Accordingly, the at least one first electronic advertising content can include a plurality of electronic advertising content, each of the plurality corresponding to one or more of an advertiser, product genre, service genre, production style, a price, a quantity, sales terms, lease terms, and/or a target demographic. Using a plurality of first electronic advertising content, step 608 can include cross-correlating the plurality of one or more of the advertiser, the product genre, the service genre, the production style, the price, the quantity, the sales terms, the lease terms, or the target demographic to the at least one physiological or physical change in the person. The cross-correlation can determine a predicted degree of interest in one or more of the product genre, service genre, production style, price, quantity, sales terms, lease terms, and/or target demographic.

Cross-correlation can include performing an analysis of variance (ANOVA) to determine a response to one or more of the advertiser, the product genre, the service genre, the production style, the price, the quantity, the sales terms, the lease terms, or the target demographic with reduced confounding compared to correlation to a single first electronic advertising content. This can substantially deconfound the response, or eliminated confounding in a response to a single first electronic advertising content. In other words, electronic advertising content generally can include several properties (advertiser, product genre, service genre, production style, price, quantity, sales terms, lease terms, target demographic, etc.). If a person responds relatively favorably to some electronic advertising content and relatively unfavorably to other electronic advertising, established statistical methods or numerical equivalents referred to as ANOVA can be used to separate the effect of one variable (e.g. product genre) from the effect of another variable (e.g. production style). This is referred to as deconfounding the data, with the unresolved response being referred to as being confounded. For example, it can be determined that a person responds favorably to candy advertising, and also responds favorably to a production style that uses cartoon characters, but responds unfavorably to a particular brand of candy (advertiser). Accordingly, cross-correlation of a plurality of responses to a plurality of advertising can be used to adjust content or other parameters to provide advertising selected to elicit a more favorable response from the person.

Referring to step 606, which can be a part of step 608, a temporal relationship between outputting the first electronic advertising content (corresponding to at least one of an advertiser, product genre, service genre, production style, a price, a quantity, sales terms, lease terms, and/or target demographic) can be correlated to the physiological or physical change in the person. Step 606 can further include saving data corresponding to the temporal relationship and processing the data to determine a response model 612 for the person. A response model can include, for example, an algebraic expression or look-up table (LUT) configured to predict a response of the person to one or more media contents or attributes. Accordingly, in steps 610 and 602, selecting and outputting at least one second electronic advertising content responsive to the predicted degree of interest in the first electronic advertising content can include calculating or looking-up one or more media contents or attributes corresponding to the second electronic advertising content using the algebraic expression or look-up table. As described above, the one or more media contents or attributes can include one or more of an advertiser, a product genre, service genre, production style, a price, a quantity, sales terms, lease terms, and/or a target demographic.

In some embodiments, a unit of electronic media, such as a media file or a commercial in stream of media, can have a desired physiological or physical response in a person exposed to the electronic media unit. Such a desired response may be referred to as a response profile. The response profile can be included in or referenced by the media unit, such as in a file header, in a watermark carried by the electronic media, at an IP address or URL referenced by the media. Put into the vocabulary used above, the relative favorability of a physiological or physical change in a person can be determined according to a response profile included in or referenced by the first electronic advertising content. The response profile can be in the form of an algebraic or logical relationship. For example, a coefficient corresponding to a media attribute can be incremented when the at least one physiological or physical change in the person corresponds to the response profile. Alternatively, a coefficient corresponding to a media attribute can be decremented when the at least one physiological or physical change in the person corresponds inversely to a factor included in the response profile. Media can thus be selected according to similarity between one or more coefficients corresponding to observed responses and coefficients present in response profiles of candidate media content.

Referring to step 602, outputting at least one second electronic advertising content responsive to the predicted degree of interest in the first electronic advertising content includes not outputting a candidate second electronic advertising.

Referring to step 608, correlating the at least one physiological or physical change in the person with the predicted degree of interest in the first electronic advertising content can include determining a negative correlation. In such a case, step 602, outputting at least one second electronic advertising content responsive to the predicted degree of interest in the first electronic advertising content can include or consist essentially of not outputting second electronic advertising content corresponding to the negative correlation. For example, outputting at least one second electronic advertising content responsive to the predicted degree of interest in the first electronic advertising content in step 602 can include outputting second electronic advertising content not sharing one or more of an advertiser, a product genre, service genre, production style, a price, a quantity, sales terms, lease terms, or a target demographic with the first electronic advertising content.

Alternatively, correlating the at least one physiological or physical change in the person with the predicted degree of interest in the first electronic advertising content in step 608 can include making an inference of high interest by the person. In such a case, outputting at least one second electronic advertising content responsive to the predicted degree of interest in the first electronic advertising content in step 602 can include outputting second electronic advertising content sharing one or more attributes with the first electronic advertising content. For example, outputting at least one second electronic advertising content responsive to the predicted degree of interest in the first electronic advertising content can include outputting second electronic advertising content sharing one or more of the advertiser, the product genre, the service genre, the production style, the price, the quantity, the sales terms, the lease terms, and/or the target demographic with the first electronic advertising content.

Accordingly, outputting at least one second electronic advertising content responsive to the predicted degree of interest in the first electronic advertising content in step 602 can include outputting second electronic advertising content sharing one or more of an advertiser, a product genre, service genre, production style, a price, a quantity, sales terms, lease terms, and/or target demographic with the first electronic advertising content; and not sharing another of at least one of an advertiser, a product genre, service genre, production style, a price, a quantity, sales terms, lease terms, and/or target demographic with the first electronic advertising content. Alternatively, outputting at least one second electronic advertising content can include repeating the first electronic advertising content or continuing to output the first electronic advertising content.

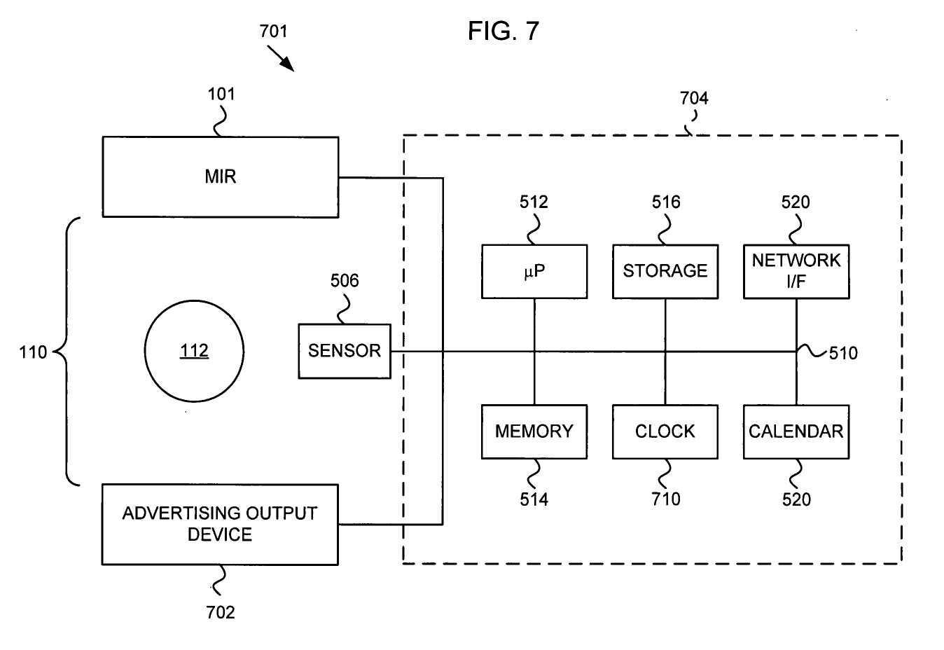

FIG. 7 is a block diagram of a system 701 for providing electronic advertising, according to an embodiment. The system 701 includes an electronic advertising output device 702 configured to output electronic advertising to a region 110. A MIR 101 is configured to probe at least a portion of the region 110 and output MIR data. According to an embodiments, the MIR data may include a MIR image, such as a planar image including pixels, a volumetric image including voxels, and/or a vector image. The MIR 101 can be configured to output a data value corresponding to a detected physical or physiological state. An electronic controller system 704 is configured to receive the MIR data from the MIR 101 and determine at least one of a physical or physiological state of a person 112 within the region. The person 112 may include a plurality of persons. For example, the electronic controller system 704 can be configured to select a media parameter responsive to the data value. Accordingly, the electronic controller system 704 can be configured to correlate the determined at least one physical or physiological state to a predicted degree of interest in electronic advertising content output via the electronic advertising output device 702, and select electronic advertising content or change a presentation parameter for output via the electronic advertising output device 702 responsive to the predicted degree of interest of the person 112.

Referring to FIG. 1, The MIR system 101 can include a transmitter 108 configured to transmit electromagnetic pulses toward the region 110, a pulse delay gate 116 configured to delay the pulses, and a receiver 118 synchronized to the pulse delay gate and configured to receive electromagnetic energy scattered from the pulses. A signal processor 120 can be configured to receive signals or data from the receiver 118 and to perform signal processing on the signals or data to extract one or more signals corresponding to at least one of the physical or physiological state of the person 110. A signal analyzer 124 can be configured to receive signals or data from the signal processor 120 and to perform signal analysis to extract, from the one or more signals, data including information associated with the physical or physiological state corresponding to the person 112 in the region 110. An interface 126 operatively coupled to the signal analyzer 124 can be configured to output MIR data including the information associated with the physical or physiological state to the electronic controller system 704.

Referring again to FIG. 7, The MIR 101 can be configured to probe the region 110 with a plurality of probe impulses spread across a period of time. The MIR data can thereby include data corresponding to changes in the at least one of the physical or physiological state of the person across the period of time. The physical and/or physiological state(s) determined from the MIR data can be correlated to the to a predicted degree of interest in electronic advertising content output by the electronic controller system by comparing the selected advertising content to the changes in the physical and/or physiological state of the person 112 across the period of time.

According to embodiments, the physiological state(s) of the person 112 can include at least one of heart rate, respiration rate, heart anomaly, respiration anomaly, magnitude of heartbeat, magnitude of respiration, magnitude or speed of inhalations, magnitude or speed of exhalations, intracyclic characteristic of a heartbeat, intracyclic characteristic of respiration, tremor, and/or digestive muscle activity. According to embodiments the physical state(s) of the person can include a location within the region 110, a direction faced by the person, movement toward the electronic advertising output device, movement away from the electronic advertising output device, speed of the person, and/or a periodicity of movement of the person.

The system 701 can include a sensor 706 such as a temperature sensor, a humidity sensor, a location sensor, a microphone, an ambient light sensor, a digital still camera, or a digital video camera; electronic memory 514, 516 such as an electronic memory containing a location; network interface 520, an electronic clock 710, and/or an electronic calendar 712 operatively coupled to the electronic controller system 704. The electronic controller system 704 can be organized as a dedicated or general purpose computer including a computer processor 512 operatively coupled to other components via a bus 510. Correlating the determined at least one physical or physiological state to a predicted degree of interest in electronic advertising content output via the electronic advertising output device 702 can include comparing, to electronic advertising content or the MIR data, data from one or more of the network interface 520, the electronic clock 710, the electronic calendar 712, the sensor 706 (e.g., the temperature sensor, the humidity sensor, the location sensor, the microphone, the ambient light sensor, the digital still camera, or the digital video camera), or the electronic memory 514, 516 containing the location. For example, the sensor(s) 706, memory 514, 516, interfaces 520, electronic clock 710, and/or electronic calendar 712 can provide context that is used by the electronic controller system 704, and the computer processor 512 to correlate the physical and/or physiological state(s) to the predicted degree of interest in electronic advertising content output via the electronic advertising output device 702.

That is, the advertising content can be selected responsive to at least one of a time, a day, a date, a temperature, a humidity, a location, an ambient light level, or an ambient sound level. For example, if MIR 101 data indicates a physiological state of the person 112 including high digestive muscle activity, indicating possible hunger, and the time received from an electronic clock 710 or a network interface 520 corresponds to shortly before a mealtime, then the system 701 can preferentially display advertising messages corresponding to nearby restaurants or available snack foods on the advertising output device 702. Adapting to responses of the person 112 can include correlating responses of the person to advertising messages selected substantially exclusively from food-related messages. Similarly, other combinations of sensor 702 and MIR 101 data can be used as input to the correlation of responses to predict a degree of interest in electronic advertising content. In this way, high value, context-sensitive advertising is delivered to the person.

While particular aspects of the present subject matter described herein have been shown and described, it will be apparent that, based upon the teachings herein, changes and modifications may be made without departing from the subject matter described herein and its broader aspects and, therefore, the appended claims are to encompass within their scope all such changes and modifications as are within the true spirit and scope of the subject matter described herein. Furthermore, it is to be understood that the invention is defined by the appended claims. It will be understood that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). If a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

With respect to the appended claims, those skilled in the art will appreciate that recited operations therein may generally be performed in any order. Examples of such alternate orderings may include overlapping, interleaved, interrupted, reordered, incremental, preparatory, supplemental, simultaneous, reverse, or other variant orderings, unless context dictates otherwise. With respect to context, even terms like “responsive to,” “related to,” or other past-tense adjectives are generally not intended to exclude such variants, unless context dictates otherwise.

While various aspects and embodiments have been disclosed herein, other aspects and embodiments are contemplated. The various aspects and embodiments disclosed herein are for purposes of illustration and are not intended to be limiting, with the true scope and spirit being indicated by the following claims.

What is claimed is:

1. A method for selecting at least one media parameter for media output to at least one person, comprising:
receiving micro-impulse radar data corresponding to a region, the micro-impulse radar data including information associated with a first physiological state corresponding to a person in the region;
selecting one or more media parameters responsive to the first physiological state; and
modifying output of a media stream to the region according to the one or more media parameters.

2. The method for selecting at least one media parameter for media output to at least one person of claim 1, wherein modifying output of a media stream to the region according to the one or more media parameters includes outputting the media stream to the region corresponding to the one or more media parameters.

3. The method for selecting at least one media parameter for media output to at least one person of claim 1, wherein modifying output of a media stream to the region according to the one or more media parameters includes stopping output of the media stream to the region.

4. The method for selecting at least one media parameter for media output to at least one person of claim 1, wherein modifying output of a media stream to the region according to the one or more media parameters includes stopping output of one media stream to the region and starting output of another media stream to the region.

5. The method for selecting at least one media parameter for media output to at least one person of claim 1, further comprising:
establishing a baseline physiological state for the person;
determining a difference physiological state corresponding to a change from the baseline physiological state to the first physiological state; and
wherein selecting one or more media parameters responsive to the first physiological state includes selecting the one or more media parameters responsive to the difference physiological state.

6-12. (canceled)

13. The method for selecting at least one media parameter for media output to at least one person of claim 1, further comprising:
recording physiological states and temporally corresponding selected one or more media parameters; and
inferring a physiological response model from the recorded physiological states and corresponding media parameters.

14. The method for selecting at least one media parameter for media output to at least one person of claim 13, wherein selecting one or more media parameters responsive to the first physiological state includes selecting the one or more media parameters responsive to the physiological response model.

15-17. (canceled)

18. The method for selecting at least one media parameter for media output to at least one person of claim 1, further comprising:
establishing a target attribute, action or response of a person;
detecting the attribute, action, or response corresponding to the person in the region;
recording physiological states and temporally corresponding attributes, actions, or responses; and
receiving, selecting, or inferring a target physiological state from the recorded physiological states and temporally corresponding attributes, actions, or responses;
wherein selecting one or more media parameters responsive to the first physiological state includes selecting the one or more media parameters having a likelihood of inducing the person to meet or maintain the target physiological state.

19-20. (canceled)

21. The method for selecting at least one media parameter for media output to at least one person of claim 18, wherein the detected attribute, action, or response is received through a data interface or detected by a sensor separate from the micro-impulse radar.

22. The method for selecting at least one media parameter for media output to at least one person of claim 21, wherein the attribute, action, or response of the person is detected by a video camera, detected by a microphone, a result of analysis of operation of controls by the person, detected by a motion sensor worn or carried by the person, or response using a touch screen, button, keyboard, or computer pointer device.

23. The method for selecting at least one media parameter for media output to at least one person of claim 18, wherein the target attribute, action or response and corresponding target physiological state corresponds to performance of one or more tasks, responsiveness to a stimulus, alertness, sleep, or calmness.

24. The method for selecting at least one media parameter for media output to at least one person of claim 18, wherein the target attribute, action or response and corresponding the target physiological state corresponds to responsiveness of the person to content of the media stream.

25. The method for selecting at least one media parameter for media output to at least one person of claim 1, wherein the micro-impulse radar data further includes one or more of information related to posture, location of the person in the region, body movements of the person, movement of the person through the region, a direction the person is facing, physical characteristics of the person, number of persons in the region, or a physical relationship between two or more persons in the region.

26. The method for selecting at least one media parameter for media output to at least one person of claim 25, wherein the one or more media parameters are further selected as a function of at least one of the posture, the location of the person in the region, the body movements of the person, the movement of the person through the region, the direction the person is facing, the physical characteristics of the person, the number of persons in the region, or the physical relationship between two or more persons in the region.

27-28. (canceled)

29. The method for selecting at least one media parameter for media output to at least one person of claim 1, wherein the first physiological state corresponds, at least in part, to an autonomic nervous system state in the person.

30-36. (canceled)

37. The method for selecting at least one media parameter for media output to at least one person of claim 1, wherein the micro-impulse radar data further includes spatial information corresponding to the person; and
wherein selecting the media parameter includes selecting the media parameter corresponding to the spatial information.

38-43. (canceled)

44. The method for selecting at least one media parameter for media output to at least one person of claim 1, further comprising:
receiving second micro-impulse radar data corresponding to a region, the micro-impulse radar data including information associated with a second physiological state corresponding to a person in the region;
comparing the first physiological state to the second physiological state; and
modifying one or more of the media parameters responsive to the comparison between the first and second physiological states.

45-46. (canceled)

47. The method for selecting at least one media parameter for media output to at least one person of claim 1, wherein the first physiological state includes at least one of heart rate, respiration rate, heart anomaly, respiration anomaly, magnitude of heartbeat, magnitude of respiration, magnitude of inhalations, speed of inhalations, magnitude of exhalations, speed of exhalations, intracyclic characteristic of a heartbeat, intracyclic characteristic of respiration, hydration state, tremor, or digestive muscle activity.

48. The method for selecting at least one media parameter for media output to at least one person of claim 1, wherein the media parameter includes at least one of media content, media delivery modality, media delivery device selection, a musical beat frequency, an audio volume, an audio balance, an audio channel separation, an audio equalization, an audio resolution, a dynamic range, a language selection, a video brightness, a video color balance, a video contrast, a video sharpness, a video resolution, a video zoom, a video magnification, 3D versus 2D display, 3D depth setting, a playlist, an artist, a genre, an advertising product or service category, an advertising content expansion, a game content, a game logic, a game control input, a gameplay speed, a data display rate, or a haptic output.

49-52. (canceled)

53. The method for selecting at least one media parameter for media output to at least one person of claim 1, further comprising:
receiving second data, the second data being provided from a sensor or source other than the micro-impulse radar; and
also selecting the one or more media parameters responsive to the second data.

54. (canceled)

55. The method for selecting at least one media parameter for media output to at least one person of claim 53, wherein the second data includes one or more of a time, a day, a date, a temperature, a humidity, a location, an ambient sound level, an ambient light level, or a video image.

56-58. (canceled)

59. The method for selecting at least one media parameter for media output to at least one person of claim 1, wherein outputting the media stream includes outputting one or more of video media, audio media, image media, text, haptic media, an advertisement, entertainment, news, data, software, or information.

60. The method for selecting at least one media parameter for media output to at least one person of claim 1, wherein selecting one or more media parameters responsive to the first physiological state includes selecting the one or more media parameters as a function of a time history of micro-impulse radar data.

61. A system for providing a media stream to a person responsive to a physiological response of the person, comprising:
a micro-impulse radar system configured to detect, in a region, a first physiological state associated with a person; and
a media player operatively coupled to the micro-impulse radar system and configured to play media to the region responsive to the detected first physiological state associated with the person.

62. The system for providing a media stream to a person responsive to a physiological response of the person of claim 61, further comprising:
a controller operatively coupled to the micro-impulse radar system and the media player, the media controller being configured to select one or more media parameters responsive to the first physiological state.

63. The system for providing a media stream to a person responsive to a physiological response of the person of claim 62, wherein the controller further comprises:
at least one sensor or sensor interface configured to sense or receive second data corresponding to the environment of the region; and
wherein the controller is also configured to select the one or more media parameters responsive to the second data corresponding to the environment of the region.

64. The system for providing a media stream to a person responsive to a physiological response of the person of claim 63, wherein the second data includes one or more of a time, a day, a date, a temperature, a humidity, a location, an ambient sound level, an ambient light level, or a video image.

65. The system for providing a media stream to a person responsive to a physiological response of the person of claim 62, wherein the controller is further configured to drive the media player to output media to the region according to the selected one or more media parameters.

66. The system for providing a media stream to a person responsive to a physiological response of the person of claim 62, wherein the controller is further configured to establish a baseline physiological state and determine a difference physiological state corresponding to a difference between the baseline physiological state and the first physiological state; and
wherein selection of the one or more media parameters includes selection of the one or more media parameters responsive to the difference physiological state.

67-71. (canceled)

72. The system for providing a media stream to a person responsive to a physiological response of the person of claim 62, wherein the controller is further configured to:
store a record of detected physiological states as a function of time;
store a record of selected one or more media parameters as a function of time; and
infer, receive, or select a physiological response model corresponding to the tracked physiological states and corresponding media parameters.

73. The system for providing a media stream to a person responsive to a physiological response of the person of claim 72, wherein the controller is further configured to:
apply the physiological response model to select one or more media parameters.

74-75. (canceled)

76. The system for providing a media stream to a person responsive to a physiological response of the person of claim 62, wherein the controller is further configured to:
establish a target physiological state; and
select one or more media parameters having a likelihood of meeting or maintaining the target physiological state.

77-78. (canceled)

79. The system for providing a media stream to a person responsive to a physiological response of the person of claim 76, wherein the target physiological state corresponds to high productivity performing one or more tasks, alertness, interest in media content, an emotional state, wakefulness, sleep, calmness, exercise activity, a pace of exercise, a meditative state, attentiveness, or responsiveness to an advertising message.

80. The system for providing a media stream to a person responsive to a physiological response of the person of claim 61, wherein the micro-impulse radar is further configured to detect spatial information; and
wherein the media player is configured to play media to the region responsive to both the detected first physiological state associated with the person and the spatial information.

81. The system for providing a media stream to a person responsive to a physiological response of the person of claim 80, wherein the spatial information includes one or more of information related to posture, a location of the person in the region, body movements of the person, movement of the person through the region, a direction the person is facing, physical characteristics of the person, number of persons in the region, a physical relationship between two or more persons in the region, and gender of the person.

82. The system for providing a media stream to a person responsive to a physiological response of the person of claim 61, wherein the first physiological state includes at least one of heart rate, respiration rate, heart anomaly, respiration anomaly, magnitude of heartbeat, magnitude of respiration, magnitude of inhalations, speed of inhalations, magnitude of exhalations, speed of exhalations, intracyclic characteristic of a heartbeat, intracyclic characteristic of respiration, tremor, or digestive muscle activity.

83. The system for providing a media stream to a person responsive to a physiological response of the person of claim 61, wherein the media player is configured to play media to the region corresponding to one or more media parameters selected responsive to the detected first physiological state associated with the person.

84-93. (canceled)

94. A method for targeted electronic advertising, comprising:
detecting with a micro-impulse radar at least one physiological or physical change in a person exposed to a first electronic advertising content;
correlating the at least one physiological or physical change in the person with a predicted degree of interest in the first electronic advertising content; and
outputting at least one second electronic advertising content or changing a parameter of the first electronic advertising content responsive to the predicted degree of interest in the first electronic advertising content.

95-96. (canceled)

97. The method for targeted electronic advertising of claim 94, wherein the at least one first electronic advertising content includes content corresponding to one or more of an advertiser, a product genre, a service genre, a production style, a price, a quantity, sales terms, lease terms, or a target demographic; and
wherein correlating the at least one physiological or physical change in the person with a predicted degree of interest in the first electronic advertising content includes correlating the at least one physiological or physical change to one or more of the advertiser, the product genre, the service genre, the production style, the price, the quantity, the sales terms, the lease terms or the target demographic.

98-103. (canceled)

104. The method for targeted electronic advertising of claim 94, wherein the physical change includes one or more of a change in posture, a change in location within the region, a change in direction faced, a decrease in body movements, an increase in body movements, or a change in speed.

105. The method for targeted electronic advertising of claim 94, wherein correlating the at least one physiological or physical change in the person with a predicted degree of interest in the first electronic advertising content further comprises:
determining a temporal relationship between outputting the first electronic advertising content corresponding to at least one of an advertiser, product genre, service genre, production style, a price, a quantity, sales terms, lease terms, or target demographic and the physiological or physical change in one or more persons.

106. The method for targeted electronic advertising of claim 105, further comprising:
saving data corresponding to the temporal relationship; and
processing the data to determine a response model for the one or more persons.

107-114. (canceled)

115. The method for targeted electronic advertising of claim 94, wherein outputting at least one second electronic advertising content responsive to the predicted degree of interest in the first electronic advertising content includes not outputting a candidate second electronic advertising.

116. The method for targeted electronic advertising of claim 94, wherein outputting at least one second electronic advertising content responsive to the predicted degree of interest in the first electronic advertising content includes continuing to output the first electronic advertising content or outputting the first electronic advertising content again.

117. (canceled)

118. The method for targeted electronic advertising of claim 94, wherein correlating the at least one physiological or physical change in the person with the predicted degree of interest in the first electronic advertising content includes making an inference of high interest by the person; and
wherein outputting at least one second electronic advertising content responsive to the predicted degree of interest in the first electronic advertising content includes outputting second electronic advertising content sharing one or more attributes with the first electronic advertising content.

119. The method for targeted electronic advertising of claim 118, wherein outputting at least one second electronic advertising content responsive to the predicted degree of interest in the first electronic advertising content includes outputting second electronic advertising content sharing one or more of an advertiser, a product genre, a service genre, a production style, a price, a quantity, sales terms, lease terms, or a target demographic with the first electronic advertising content.

120-121. (canceled)

122. A system for providing electronic advertising, comprising:
an electronic advertising output device configured to output electronic advertising to a region;
a micro-impulse radar configured to probe at least a portion of the region and output micro-impulse radar data; and
an electronic controller system configured to receive the micro-impulse radar data and determine at least one of a physical or physiological state of a person within the region, correlate the determined at least one physical or physiological state to a predicted degree of interest in electronic advertising content output via the electronic advertising output device, and select electronic advertising content or change a presentation parameter for output via the electronic advertising output device responsive to the predicted degree of interest.

123. (canceled)

124. The system for providing electronic advertising of claim 122, wherein the micro-impulse radar is configured to probe the region with a plurality of probe impulses spread across a period of time.

125. The system for providing electronic advertising of claim 124, wherein the micro-impulse radar data includes data corresponding to changes in the at least one of the physical or physiological state of the person across the period of time.

126. The system for providing electronic advertising of claim 125, wherein correlation of the determined at least one physical or physiological state to a predicted degree of interest in electronic advertising content output by the electronic controller system includes comparing the selected advertising content to the changes in the at least one of the physical or physiological state of the person across the period of time.

127. (canceled)

128. The system for providing electronic advertising of claim 122, wherein the physiological state of the person includes at least one of heart rate, respiration rate, heart anomaly, respiration anomaly, magnitude of heartbeat, magnitude of respiration, magnitude of inhalations, speed of inhalations, magnitude of exhalations, speed of exhalations, intracyclic characteristic of a heartbeat, intracyclic characteristic of respiration, tremor, or digestive muscle activity.

129. The system for providing electronic advertising of claim 122, wherein the physical state of the person includes one or more of a location within the region, a direction faced by the person, the person's posture, movement toward the electronic advertising output device, movement away from the electronic advertising output device, or a periodicity of movement of the person.

130. The system for providing electronic advertising of claim 122, further comprising at least one of a network interface, an electronic clock, and electronic calendar, a temperature sensor, a humidity sensor, a location sensor, an electronic memory containing a location, a microphone, an ambient light sensor, a digital still camera, or a digital video camera operatively coupled to the electronic controller system; and
wherein correlating the determined at least one physical or physiological state to a predicted degree of interest in electronic advertising content output via the electronic advertising output device includes comparing, to electronic advertising content or the micro-impulse radar data, data from one or more of the network interface, the electronic clock, the electronic calendar, the temperature sensor, the humidity sensor, the location sensor, the electronic memory containing the location, the microphone, the ambient light sensor, the digital still camera, or the digital video camera.

131. (canceled)
